(19) United States
(12) Patent Application Publication
(10) Pub. No.: US 2007/0217292 A1
(43) Pub. Date: Sep. 20, 2007

(54) Digital calendar

(76) Inventor: Alvin Williams, Vineland, NJ (US)

Correspondence Address: CHRISTOPHER D. HARRINGTON, SUITE 350, 5300 CORPORATE GROVE DR SE, GRAND RAPIDS, MI, 49512, US

(21) Appl. No.: 11/374,094

(22) Filed: Mar. 14, 2006

(51) Int. Cl. G04C 17/00

(52) U.S. Cl. 368/29

(57) ABSTRACT

A novel digital calendar is disclosed for the retention of a user's schedule and events, and for displaying and communicating the user's schedule and events pursuant to an instruction set that manages the operations of the digital calendar. The digital calendar comprises an oversized display that is retained in a housing, with a keyboard for inputting data, a microprocessor for management of the functions of the digital calendar, a speaker/microphone for inputting and outputting audible messages, and a power supply. The microprocessor includes an instruction set that defines the operation the digital calendar. In one embodiment of the present invention, a remote is provided for the remote entry and receipt of inputs and outputs from the digital calendar.

### RELATED APPLICATIONS

Not applicable.

### STATEMENT REGARDING GOVERNMENTALLY FUNDED WORK

Not applicable.

### BACKGROUND OF THE INVENTION

The present invention relates to a digital calendar. More particularly, the present invention relates to a digital calendar that has an oversized display for use by persons who are vision challenged and which provides an audible message relating to events.

For people who suffer from limited vision or who may have other disabilities that impair the use of conventional items such as printed calendars or memo pads, the need exists for a device that circumvents their disability and allows them to manage their affairs in the same manner as people who are fully able to take advantage of printed calendars and memo pads.

In the prior art, some devices are known that do provide functions relating to messages in general and which may or may not provide some level of assistance to those with disabilities of differing types. For instance, U.S. Pat. No. 5,708,627 (Gormley) teaches an electronic clock and calendar that has a voice recorder that will accept voice messages for playback at specified times. The device does not provide a visual indication that is geared towards the visually impaired nor does it provide a display of the calendar in the usual calendar format. Similarly, in U.S. Pat. No. 4,783,800 (Levine) teaches the use of an electronic scheduler that can make and record appointments over the phone. This system does not relate at all to a visually displayed calendar system even though it does record and can impart audible messages to users relating to appointments and other calendared events.

In U.S. Pat. No. 5,093,854 (Sucato) a calendar device is integrated with a phone system to allow remote access to stored messages relating to scheduled events. This device is not directed towards users who are visually disabled nor does it provide information in the traditionally displayed calendar format. The function of message storage and retrieval is very different from the present invention as well. In U.S. Pat. No. 5,199,009 (Svast) teaches the use of a programmable clock face that will record dates relating to events and then provide reminders both audibly and visually. The reminder clock interacts with the user in a way that is very different from that where one is enhancing the efforts of a disabled person, especially one who is visually disabled. The reminder clock does not include any calendar display that would be user friendly with respect to the visually disabled.

In U.S. Design Pat. No. 334,945 (Hill) the design for an electronic calendar is disclosed where the display appears to show the typical calendar format. There is no other guidance or teaching in this prior art reference to indicate to what extent the electronic calendar can provide information that is useable to a person who is visually disabled. Nor is there any teaching with respect to the integration of messaging with the visual display. Similarly, in U.S. Pat. No. 4,712,923 (Martin) an electronic calendar is taught without a visual display that would be consistent with supporting the needs of a visually impaired person. There is no integration of audible signals or messaging as well.

As may now be appreciated, there has been no solution offered for those visually impaired persons who have a need to participate in life's daily activities, whether this is business or social, and would find the use of a calendar or organizer helpful. The prior art devices are directed towards very specific uses and do not contemplate the needs of the visually impaired with respect to the objects of such inventions. The need for a display that can be easily and conveniently used by a visually impaired person along with the integration of audible signals and reminder playbacks is functionality that has not been shown or even contemplated in the prior art.

It is submitted that the present invention solves many of the aforementioned and longstanding problems that have been known, as well as providing other functional attributes that are not known in the prior art. These features and developments will be discussed in more detail below.

### SUMMARY OF THE INVENTION

A novel digital calendar comprises an oversized display in a housing, with a keyboard for inputting data, a microprocessor for management of the functions of the digital calendar, a speaker/microphone for inputting and outputting audible messages, and a power supply. The microprocessor includes an instruction set that defines the operation the digital calendar. The display may provide a representation of a calendar year, or a calendar month, or calendar days the selection of which is synchronized by the instruction set in the microprocessor with data relating to events, or schedules, and with other functions of the digital calendar.

In one embodiment of the present invention, the digital calendar includes a remote which contains the keyboard and the speaker/microphone. The remote is capable of transmitting and receiving between it and the display and can be employed by the user to input data or to hear audible messages without having to be close proximity with the display portion of the digital calendar. The remote is preferably capable of docking with the digital calendar.

The digital calendar of the present invention is preferably powered by a rechargeable battery source allowing the digital calendar to be kept in view, at times, independent from any need to have it have plugged into a household AC power supply.

These and other attributes and features of the present invention will be discussed in more detail below.

### BRIEF DESCRIPTION OF THE DRAWINGS

FIG. 1 is an isometric view of the digital calendar of the present invention with the remote in the docked condition.

FIG. 2 is an isometric view of the remote of the digital calendar of the present invention in the undocked condition.

FIG. 3 is a cross sectional view of the digital calendar of FIG. 1 taken along Section Lines 3-3.

FIG. 4 is an isometric view showing the power supply for the digital calendar of the present invention, in close proximity to a portion of the side of the digital calendar.

### DETAILED DESCRIPTION OF THE PREFERRED EMBODIMENTS

A novel digital calendar in accordance with the present invention is shown in the drawings and is discussed in detail within this section. The benefits of the present invention are primarily directed towards assisting those who may have some sensory disability, typically visual in nature, by providing a means for organizing their daily, weekly, monthly, and yearly affairs as is commonly done by non-disabled persons. Notwithstanding the primary beneficiary of the invention, the digital calendar taught herein can be used in fact by virtually any person without regard to their abilities. For some, the features that are provided may be attractive and desired notwithstanding their non-disabled status. It is also thought that many people who are of advanced age would find the present invention desirable notwithstanding any congenital disability but the natural consequences of the aging process.

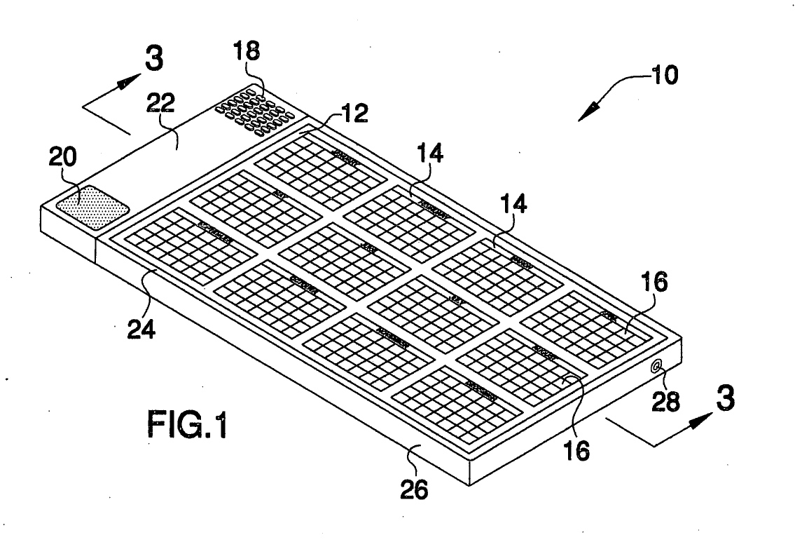

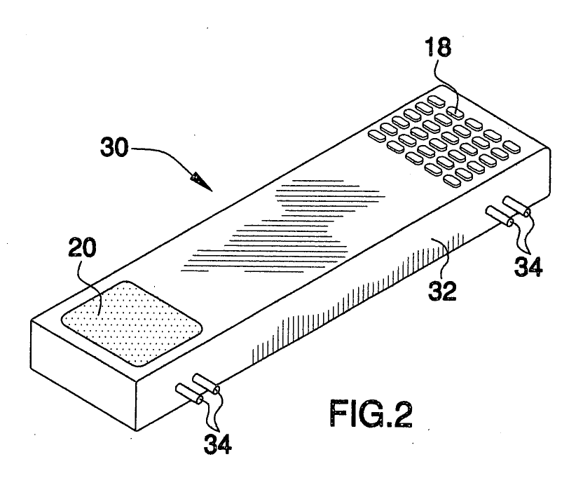

Turning now to the drawings, in FIG. 1 a general overview of the digital calendar 10 can be appreciated with the display 12, which is further broken down into segments representing months 14 and days 16. The digital calendar 10 further includes a keypad 18, a speaker/microphone 20, the housing 22 and with the housing top 24, the housing sides 26. Also shown is the power supply input 28. In FIG. 2 the keypad 18 and the speaker/microphone 20 are shown as residing on the remote 30 which includes the remote housing 32 and the input/output connections 34.

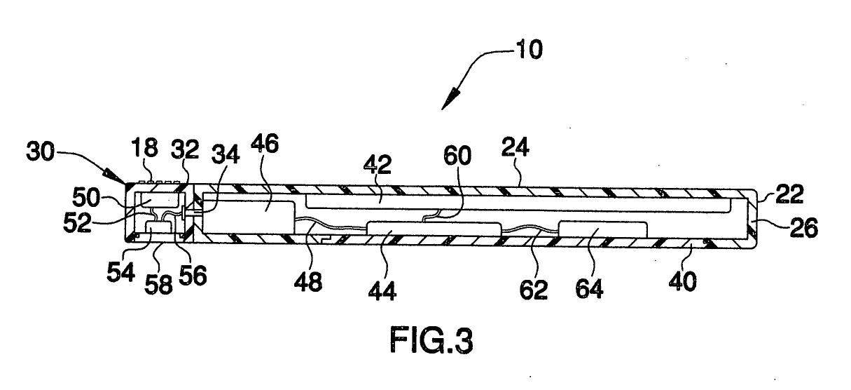

FIG. 3 reveals a portion of the interior of the digital calendar 10, with the housing bottom 40, the calendar display module 42, the microprocessor 44, the input/output port 46, which is connected to the microprocessor 44 by the input/output lead 48. The keypad module 50 is located within the remote 34 portion of the digital calendar 10 and includes the keypad module lead 52 that connects to the input/out board 54 which the connection lead 56 connects to the input/output connection 34. The remote portion 30 also includes the access door 58. The interior of the digital calendar 10 includes the display lead 60 which connects the microprocessor 44 to the calendar display module 42. The power lead 62 connects the battery 64 to the microprocessor 44.

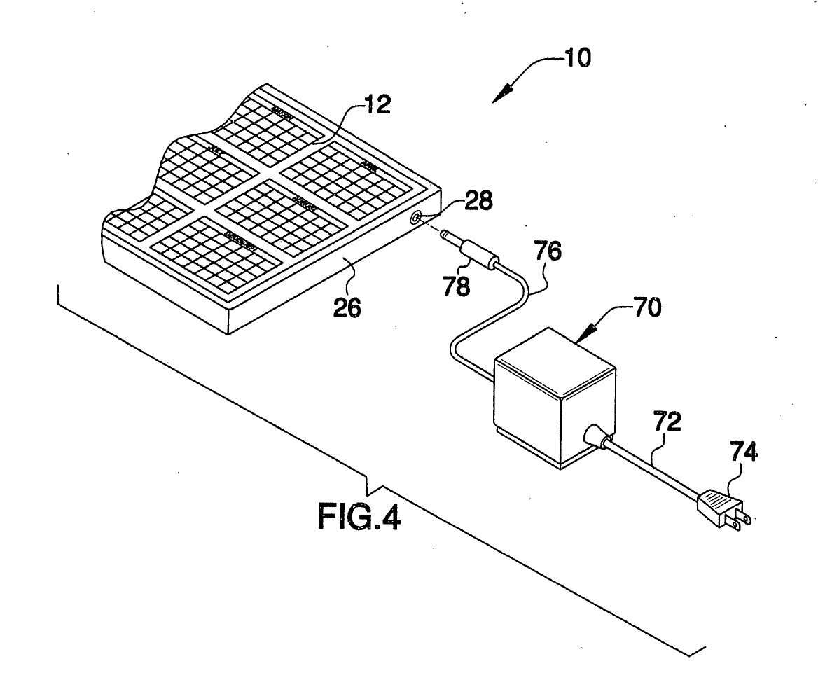

Turning now to FIG. 4, the power supply 70 is shown (an A.C. to D.C. transformer) with the AC line cord 72, the AC plug 74, the DC line cord 76 and the DC plug 78.

With reference to the drawings it can be appreciated how the present invention may be placed into use. The digital calendar 10 preferentially utilizes a rechargeable battery 64 which can be recharged using the power supply 70. This allows some portability whereby the digital calendar 10 can be moved about by the user and even hung on a wall or taken along for trips outside the home. The battery 64 allows for many hours of use in the normal situation.

The keypad 18 may be used to actuate the digital calendar, which will energize the components and commence operation of the display 12. For this purpose, the keypad 18 may include an on/off switch or the input from a key on the keypad 18 may be set to trigger the commencement of the digital calendar 10 operations. The display 12 is typically configured to show a formatted appearance which can include the portrayal of the months 14 in a given year, or the days 16 in a given month or week. The format shown in the drawings is based upon a grid of four months 14 across and three months 14 down to reflect the months 14 in the year. In use, the display may be called upon to show just a single month 14, or it may show a number of days 16 such as the days 16 in a given week. The actual format can be generated by the microprocessor 44 and appears on the display 12. The display 12 is typically an LCD display which has the advantage of being a low cost component and which also uses relatively small amounts of battery power in use. The preferred LCD display 12 is suited to show the various configurations that can be selected by the user.

The instruction set used by the microprocessor 44 to manage the operations of the digital calendar 10, includes the ability to take inputted data and associate it with a given date, time, and subject. The data may be used to generate a visual message on the display 12, or it may be used to generate an audible message through the speaker/microphone 20. An example of this interaction between the user and the digital calendar 10 would include a situation where the user determines that he/she would like to notate an appointment at some future date and time. The user may input this message through the use of the keypad 18 and the speaker/microphone 20. The date and time are notated and the user can enter a verbal message that will be tagged with the event. Depending on the instruction set, the verbal message may be triggered automatically to play back at various times, such as the day before the event, or the day of the event, or at times just prior to the scheduled event. In addition, the user can activate the audio playback by appropriately entering an input to the digital calendar 10 that requests information on the particular date in question, or for a playback of upcoming events. In yet another mode of operation, the digital calendar 10 may cause the display 12 to flash to indicate a pending event. Depending on the instruction set, the flashing can be made to occur across the whole display 12 or it can be focused onto the day 16 on which the event is being recognized. Any number of combinations of requests and instructions can be made operative with the objective being the convenience of use for the user.

The benefits of the display include its overall size. Preferably, the digital calendar 10 of the present invention is made to be oversized as compared to hand held calendar devices that are known. In fact, the preferred size of the present invention is approximately 30″ by 36″ (height by width) which results in a display 12 that is proportionately large as well. It is anticipated that the components of the digital calendar 10 will be adequately retained in the housing 22 which may only be ½″ in thickness although it may be more than this if desired. The display 12 will, in this instance, portray the calendar configurations in such sizes as will allow many users with visual impairments to see the calendar and to interact with it. In one version of the present invention, the display 12 is itself interactive and will respond to touch or the placement of a stylus (not shown) onto the display 12 itself and will, for instance, audibly report the message associated with an appointment or a date, or similar information. This allows for a “user friendly” operation that minimizes the need for the user to have to rely upon the keypad 18.

It should be appreciated that the various ways that the data can be inputted and outputted with respect to the digital calendar cannot all be illustrated within this specification; the examples discussed are meant to illustrate ways that can be implemented. Certainly one skilled in the art can provide instruction sets for the operation of the digital calendar 10 that may manage the data in different ways all of which would be considered within the scope and teachings of the present invention. It is also understood that the microprocessor 44 as taught herein is an integrated unit with its own memory capacity, however, it is possible to include separate components for storage of memory and for a central processing unit (CPU) all of which would be within the scope of the teachings herein. The data that is used in the operation of the digital calendar 10 is typically stored within the memory of the integrated microprocessor 44, although as indicated, this may be augmented by separate components dedicated just to memory storage and retrieval.

The remote 30 can be detached from the digital calendar 10 as shown in the drawings. The advantage in this is again to facilitate the ease of use of the present invention for those who may have disabilities of one kind or another. For instance, a user may have limited use of his/her arms or may be confined to a wheelchair, in which case the use of a remote 30 that is able to interact with the digital calendar 10 still allows the user to manage his/her own affairs in a conventional manner. The remote 30 will typically have its own power supply (not shown) which can comprise a set of batteries that can be replaced or recharged. When detached from the digital calendar 10, the remote 30 is able to transmit inputs and received outputs (verbal messages routed through the speaker/microphone 20 located on the remote 30) from the digital calendar 10. The remote 30 is also able to send inputs via the keypad 18 which may include Braille lettering on the individual keys and which the user would use to key in data and information to be used by the digital calendar 10. Wireless communication of this type is well known in the art, however in the case of the present invention, the wireless communication allows the user the freedom to be physically separated from the digital calendar 10 which can be hung in a place where the user can see the visual indications as he/she uses the remote 30 to interact with the invention. The input/output connections 34 located on the remote 30 match up with the input/output port 46 located in the digital calendar housing 22. This allows the remote 30 to easily dock with the digital calendar and to maintain operations when the remote 30 is so engaged.

The digital calendar 10 operation is flexible enough to admit to peripheral functions that may further aid the user. For instance, the digital calendar 10 may be equipped with a motion detector to allow it to remain dormant (thus saving battery power) until it detects motion which typically would be the presence of the user. The digital calendar 10 can then make specified statements about the appointments, events, or reminders for the user. For the security of the user, the digital calendar 10 can be protected by passwording such that the user will input a selected password to activate the digital calendar 20 thus preventing others from accessing the calendared information. In yet another version of the present embodiment, the benefits of the digital calendar 10 can be integrated with telephone communications, either on a hard wired or wireless basis or through a cell-phone connection. It would then be possible for the user to access the digital calendar 10 through telephone contact and to either input a message or to receive messages relating to the user's schedule and events. Lastly, the user may enter verbal messages relating to an appointment or an event by using the speaker/microphone 20. This function can be coordinated with the instruction set for the microprocessor 44 to store the voice data and then play it back when the event is pending. In addition, the microprocessor 44 may easily be equipped with a voice generator so that voice messages may be generated automatically by the digital calendar 10 thereby providing announcements upon the happening of a specified occurrence such as a date for which appointments are scheduled, or the approach of a particular time in a day when perhaps medication may be required, and so forth.

The practice of the present invention is not meant to be limited by the examples and illustrations discussed above, which are used to teach only a few of the ways and methods that the digital calendar 10 can be used. It is understood that the digital calendar 10 may be used with or without the remote 30 and it may be configured in differing sizes or general shapes without departing from the spirit and scope of the present invention.

I claim:

1. A digital calendar for the organization display and communication of data relating to the scheduling of the affairs of a user, the digital calendar comprising:
A housing;
A display retained within said housing where the display portrays a calendar format;
A microprocessor for managing the operations of the digital calendar and for the storage and retrieval of data stored in memory including an instruction set for the microprocessor;
Inputs for inputting data into memory;
A speaker for outputting audible messages;
A power supply for energizing the components of the digital calendar; and,
Where the display comprises an oversized display suitable for use by persons who are visually impaired and where information relating to the occurrence of a scheduled event is shown on the display and is communicated by an audible message emanating from the speaker.

2. The digital calendar of claim Number 1, where the oversized display is approximately 30″ in height and 36″ in width.

3. The digital calendar of claim Number 1, where the digital calendar further includes a wireless remote with a speaker, for the inputting of data to the digital calendar and for the receipt and output of audible messages.

4. The digital calendar of claim Number 1, where the inputs for inputting data include a microphone for the input of verbal messages, and a keypad for the entry of information to the digital calendar.

5. A digital calendar for the organization display and communication of data relating to the scheduling of the affairs of a user, the digital calendar comprising:
A housing;
A display retained within said housing where the display portrays a calendar format;
A microprocessor for managing the operations of the digital calendar and for the storage and retrieval of data stored in memory including an instruction set for the microprocessor;
Inputs for inputting data into memory comprising at least a wireless remote with a keypad for the inputting of data and a speaker/microphone for the inputting of data and the receipt and output of audible messages;
A power supply for energizing the components of the digital calendar; and,
Where the display comprises an oversized display suitable for use by persons who are visually impaired and where information relating to the occurrence of a scheduled event is shown on the display and is communicated by an audible message emanating from the speaker.

6. The digital calendar of claim Number 5, where the inputs for inputting data include a microphone for the input of verbal messages, and a keypad for the entry of information to the digital calendar.

7. The digital calendar of claim Number 5, where the oversized display is approximately 30″ in height and 36″ in width.

8. The digital calendar of claim Number 5, where the display is an LCD display.

9. The digital calendar of claim Number 5, where the remote is capable of docking with the digital calendar.

10. A digital calendar for the organization display and communication of data relating to the scheduling of the affairs of a user, the digital calendar comprising:
A housing;
A display retained within said housing where the display portrays a calendar format;
A microprocessor for managing the operations of the digital calendar and for the storage and retrieval of data stored in memory including an instruction set for the microprocessor;
Inputs for inputting data into memory comprising at least a wireless remote with a keypad for the inputting of data and a speaker/microphone for the inputting of data and the receipt and output of audible messages, where the remote is capable of docking with the digital calendar;
A power supply for energizing the components of the digital calendar; and,
Where the display comprises an oversized display suitable for use by persons who are visually impaired and where information relating to the occurrence of a scheduled event is shown on the display and is communicated by an audible message emanating from the speaker.

11. The digital calendar of claim Number 10, where the power supply is a rechargeable battery.

12. The digital calendar of claim Number 10, where the display is an LCD display.
